(19) United States
(12) Patent Application Publication
(10) Pub. No.: US 2017/0297885 A1
(43) Pub. Date: Oct. 19, 2017

(54) LIQUID DISPENSING HEAD

(71) Applicant: Napa Technology, Campbell, CA (US)

(72) Inventors: Nick Moezidis, San Jose, CA (US); Morris Taradalsky, San Jose, CA (US); Ross Rittiman, San Jose, CA (US); Jeffrey Brooks, San Jose, CA (US); Edward A. Vetter, Santa Clara, CA (US)

(73) Assignee: Napa Technology, Campbell, CA (US)

(21) Appl. No.: 15/371,006

(22) Filed: Dec. 6, 2016

Related U.S. Application Data
(63) Continuation of application No. 14/665,935, filed on Mar. 23, 2015, now abandoned.
Application No. 14/665,935 is a continuation of application No. 13/598,482, filed on Aug. 29, 2012, now Pat. No. 8,985,404.
(60) Provisional application No. 61/528,849, filed on Aug. 30, 2011.

(51) Int. Cl. B67D 1/00; B67D 1/12; B67D 1/04

(52) U.S. Cl. CPC B67D 1/0004; B67D 1/1277; B67D 1/0412; B67D 2001/0481; B67D 2001/0098

(57) ABSTRACT

A dispense head is removably joined to a bottle, such as a wine bottle, by having a hollow cylinder extend into the bottle and on one end sealed to a neck of the bottle with gasket means for sealing the bottle in a gas tight manner and supporting the bottle, allowing the bottle to hang from the dispense head. In one embodiment a set of annular gaskets of different diameters may be provided for bottles of different neck sizes.

### CROSS-REFERENCE TO RELATED APPLICATION

This application is a continuation-in-part of U.S. patent application Ser. No. 14/665,935 filed Mar. 23, 2015, which in turn is a continuation of U.S. patent application Ser. No. 13/598,482, filed Aug. 29, 2012, now U.S. Pat. No. 8,985,404 (which claims priority from U.S. Provisional Application Ser. No. 61/528,549, filed Aug. 29, 2011).

### TECHNICAL FIELD

The embodiments relate to a method and device for dispensing liquid and, more specifically, to an improved dispense head for an automated liquid dispensing machine.

### BACKGROUND

Liquid dispensing machines, such as wine dispensing machines, are currently sold and are in increasing use and popularity. For example, Wine Station® brand liquid dispensing device sold by Napa Technologies, Inc. of Campbell, Calif. allows the precise dispensing of wine and tracking of wine dispensing and wine sales, among other features. This wine dispensing system uses gas displacement to displace a precise volume of wine. The system allows displacement of different volumes of wine allowing a pour of a taste, half glass, or full glass amount which may correspond to a 1 oz., 4 oz., or 8 oz. pour of dispensed liquid. The gas used for displacement may be nitrogen, argon or another gas which does not react with or degrade wine. This allows the system to dispense wine without affecting the taste of the wine or allowing oxidation of the wine remaining in the wine bottle between pours, even if the wine bottle is removed from the dispense system. Such a dispense system also allows better tracking of the wine inventory for a retailer since the devices are configured to connect to a centralized computer system.

One unique and advantageous feature of the Wine Station® brand wine dispensing system is the unique dispense head. With reference to FIG. 1, a profile of a dispense head 10 is shown. This dispense head includes a gas input 16 positioned at the rear of the dispense head when the dispense head is inserted into a wine dispensing machine. Gas input 16 then forms a gas-tight seal with a gas output on the machine. A metered amount of gas then flows through the machine to displace wine.

Opposite the gas input 16 is dispense spout 12. Dispense spout 12 is a hollow tube through which wine flows when wine is dispensed by the dispensing system. A rotatable valve assembly 14 is also controlled by the wine dispensing system when dispense head 10 is attached to a wine bottle and the dispense head inserted into the wine dispense machine such that gas input 16 mates with a gas output on the wine dispensing machine. Rotatable valve assembly may be rotated such that different channels within the rotatable valve assembly 14 align with different passageways within the dispense head. For example, if the gas input is simply aligned with the dispense spout 12. A puff of gas will pass through the dispense spout 12. This allows the dispense spout 12 to be cleared of any fluid which may be retained within the dispense spout. On the lower side of the dispense head 10 under the valve assembly 14 is a cap 18 which sits over the neck of a wine bottle. Within cap 18 is the tapered cylinder 26 which fits into a wine bottle. At the lower end of the tapered cylinder 26 is a tube mount 20. Onto mount 20 a tube 22 is mounted. This tube 22 extends to the bottom of a wine bottle and when gas flows from gas input 16 through holes on tapered cylinder 26 the wine is displaced and will flow into the open bottom end of tube 22 and into a channel in the dispense head 10 and out dispense spout 12.

FIG. 2 shows another view of the dispense head 10 attached to wine bottle neck 50. As seen above, cap 18 covers the top of wine bottle neck 50. Gas input 16 is opposite dispense spout 12. On the body 40 of dispense head 10 is a valve assembly cap 30. Extending through valve assembly cap 30 is a rotating tab 52. When rotating tab 52 is rotated by the wine dispensing system different pathways for gas and liquid travel are aligned. For example, if a channel from gas input 16 is blocked by rotation of rotating cap 52 no gas will flow through the system. This affectively seals the wine bottle as long as any channel leading to dispense spout 12 is also blocked. The sealed wine bottle can then be removed from a wine dispensing system and stored. The wine bottle can be exchanged with an alternative wine bottle that also has a dispense head mounted on the bottle. In a second operation the channel leading from gas input 16 is connected through to the channel leading into the tapered cylinder 26. This would cause liquid to flow up tube 22 (shown in FIG. 1) and into a channel in the dispense head 10 that leads to the dispense spout 12. In a third operation created by rotation of rotating cap 52 the gas input 16 is directly connected to dispense spout 12. This allows a puff of air to flow through the dispense spout to clear it of any liquid.

With reference to FIG. 3, an exploded view of the dispense head 10 again shows the body 40 of dispense head 10 having a dispense spout 12 at one end and a gas input 16 at the opposite end. A cap 18 is affixed below body 40 and extends above the open end of the wine bottle when the dispense head 10 is attached to the wine bottle. Seated with the valve mount 38 on body 40 is the rotatable valve assembly 14. This includes the valve assembly cap 30 positioned over rotating valve 34. The channels discussed above allowing connections of the gas input and wine output are on the underside of rotating valve 34. This can be seen in U.S. Pat. No. 7,712,631 which is hereby incorporated by reference for all purposes herein. Rotating valve 34 has a tab 34A which may be rotated by the wine dispensing system. An inner O-ring seal 32 seals rotating valve 34 to valve assembly cap 30 to prevent leaks.

On the sides of body 40 are mounted bands 36A, 36B. These bands have pins 37A, 37B which extend into the dispense spout 12. Bands 36A, 36B make an electrical connection with the wine dispense system. This allows electronic determination of whether the dispense head is properly inserted into the dispense machine. In addition the impedance may be measured as wine is dispensed. For example, the measuring of bubbles (even microbubbles) will be detectable and allow an alert that the wine level within a bottle is low. This can act as a check on other systems that measure the amount of wine dispensed. The “back end” of the system will measure the total amount of wine dispensed from any given bottle and can also provide alerts indicating that a bottle should be replaced.

The underside of the dispense head 10 includes a bottle mount assembly 80. This includes a cap 18 which extends around the neck of the wine bottle. Within cap 18 are tapered cylinder 26 which fits into a wine bottle as shown in FIG. 2. A retainer ring 82 holds intake tube mount 84. This provides the channel through which the wine will flow.

With reference to FIG. 4 the underside of dispense head 10 again shows a dispense spout 12 on one side of the device and gas input 16 on the opposing side. Cap 18 is mounted on body 40 and extends about the back of the wine bottle. A tube mount 20 on tapered cylinder 26 allows attachment of a tube which extends to the bottom of a wine bottle. Gas ports 24 allow the flow of gas into a wine bottle to establish a pressurized head. Tapered cylinder 26 is extended into the wine bottle. The taper of tapered cylinder 26 allows the dispense head to be fitted into a variety of different wine bottles having different diameter bottle neck openings.

In use, the present device has experienced some problems. For example, leakage is a possible problem in this pressurized device. Although the device is designed for use with a variety of different sized wine bottle necks, the variety of different wine bottle necks has been challenging to accommodate without gas leakage. Some attempts have been made to use washer-like spacers within wine bottle necks to form a better seal. However, given that these are not part of the dispense head this has proved non-ideal. It is an objective to provide dispense head embodiments with more robust leak prevention.

### BRIEF DESCRIPTION OF THE DRAWINGS

FIG. 1 is a side view of a prior art dispense head.

FIG. 2 is a top perspective view of the dispense head of FIG. 1 as inserted into a wine bottle.

FIG. 3 is an exploded view of the dispense head of FIG. 1.

FIG. 4 is an underside view of the dispense head of FIG. 1.

FIG. 5A is a side view of an improved dispense head.

FIG. 5B is a bottom perspective view the dispense head of FIG. 5A.

FIG. 6 is a side perspective view of a detachable pour spout.

FIG. 7A is a top view of rotatable cap.

FIG. 7B is a bottom view of the rotatable valve cap of FIG. 7A.

FIG. 7C is a top view of the cap of FIG. 7A.

FIG. 7D is a cross sectional view of the cap shown in FIG. 7A.

FIG. 7E is a detail of an internal annular resilient member.

FIG. 7F is a detail of another annular resilient member.

FIG. 7G is a cross sectional detail of the over molding.

FIG. 8 is a top perspective view of a nut.

FIG. 9 is a side view of an alternative embodiment of a dispense head.

FIG. 10 is a side view of a cylinder having annular flanges.

FIG. 11A is a bottom view of the alternative embodiment of FIG. 9.

FIG. 11B is a side perspective view of the device of FIG. 11a.

### DETAILED DESCRIPTION

The present embodiments provide a number of improved. features to a dispense head. In one embodiment, the improved features include removable and exchangeable gaskets. This feature allows for the ability to exchange or replace gaskets by simply unscrewing a threaded nut at the bottom stem of the dispense head. There is no standard for the diameter of a wine bottle neck opening. For this reason a variety of wine bottle gasket sizes are needed to adapt a dispense head to the variety of different wine bottle neck openings. The stem that is inserted into the wine bottle of a dispense head requires multiple channels to enable gas, pressurization, gas purging and liquid pouring. The present gaskets of these embodiments described herein allow a plurality of different gaskets to be secured on this stem such that it is usable for a variety of different bottle neck openings. In addition, the cap of the rotatable valve assembly includes molding that protects wine leaks from occurring through the cap when the wine bottle is pressurized. In addition the disclosed embodiments show a spout design which provides for quick removal and cleaning.

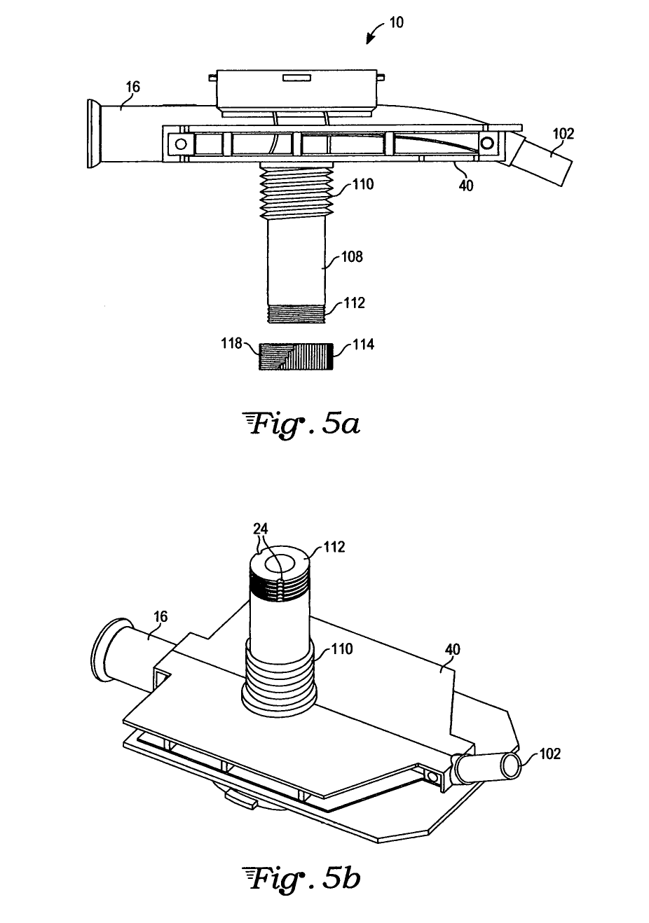

With reference to FIGS. 5A and 5B, as in the prior design the dispense head 10 includes a gas intake 16 mounted on or molded onto body 40. Opposing side body 40 includes a spout mount 102.

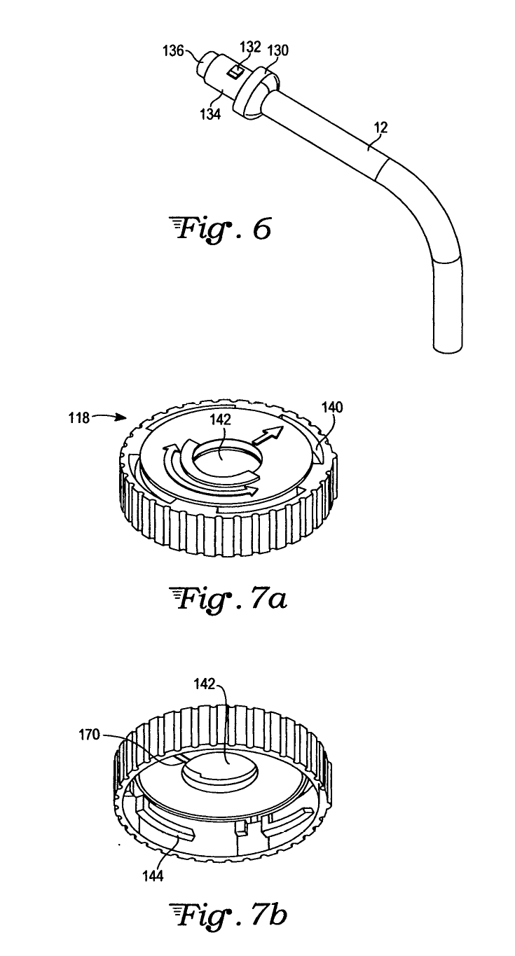

With reference to FIG. 6, onto spout mount 102 in FIGS. 5A, 5B may be mounted a pour spout 12 as shown in FIG. 6. This spout includes a mount pipe 136, a bushing 134, and a collar 130. The spout mount 102 allows the bushing 134 to fit over and mount pipe 136 to fit within spout mount 102. A resilient button 132 may lock onto spout mount 102 of FIGS. 5A, 5B to hold pour spout 12 in place. In this manner the pour spout may be easily removed for cleaning or replaced in case of damage. This may be done even while the wine bottle has a dispense head mounted on it and the interior space of the bottle pressurized.

Returning to FIGS. 5A, 5B, the body 40 also has a cylinder 108 mounted on body 40. At an upper end of bottle extending cylinder 108 are nut threads 110. At a lower end bottle extending cylinder 108 are external gasket threads 112. This allows attachment of an external gasket 114 having internal threads 118. A variety of different gasket sizes may be provided allowing the device to be used on a variety of wine bottle neck openings.

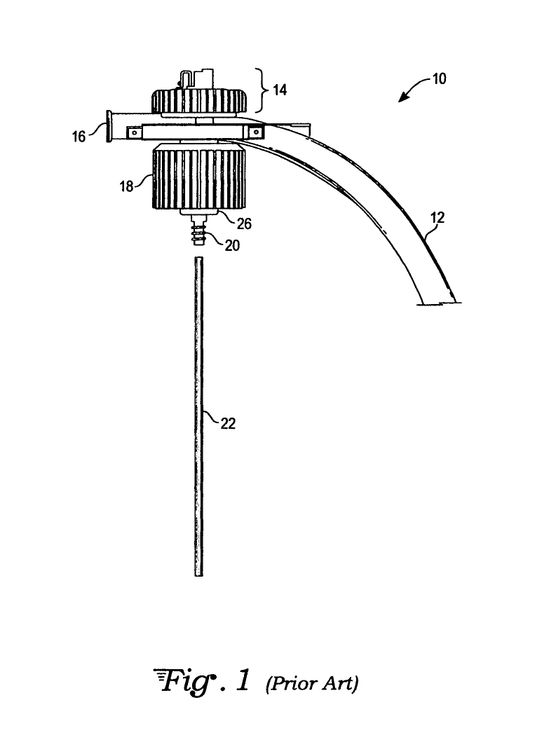

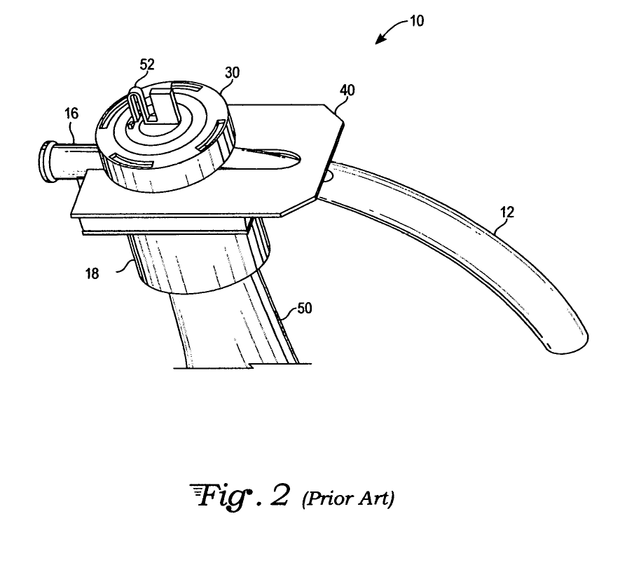

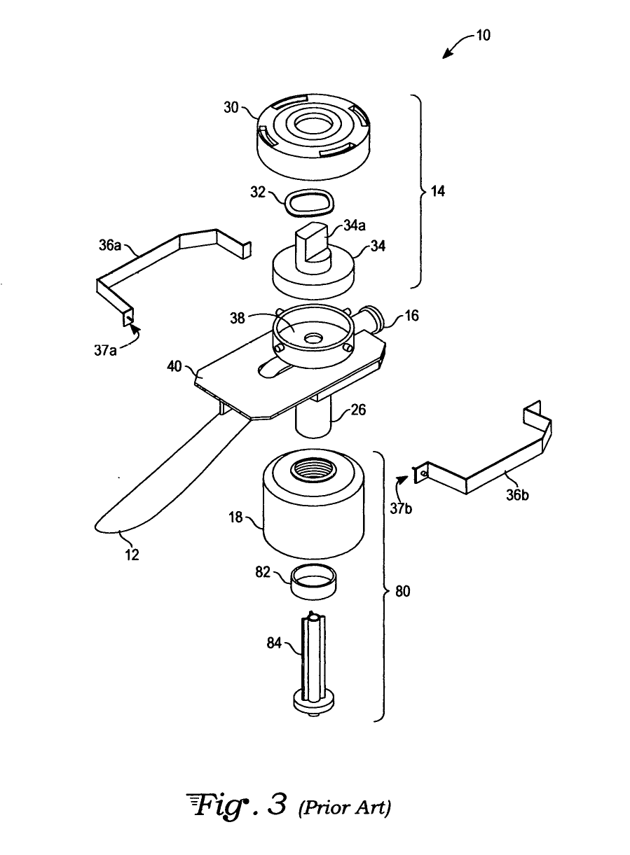

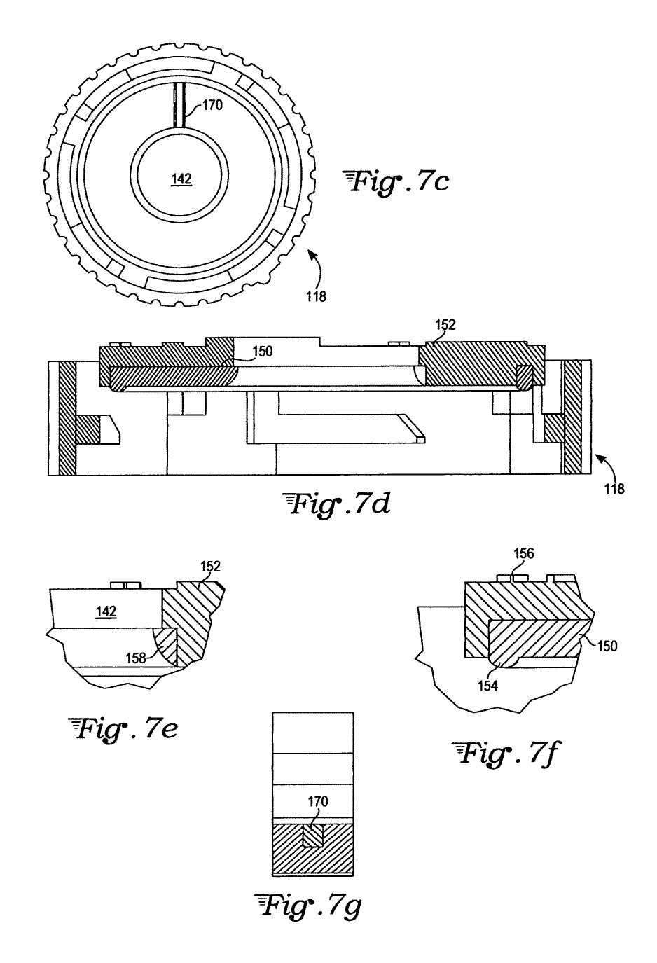

As shown in FIG. 5A, the rotatable valve assembly is shown without some parts, which are shown in FIGS. 1-4. The valve assembly portions including the valve mount and rotating valve as shown in FIG. 3 are still utilized. The cap has been modified to prevent leaks. With respect to FIGS. 7A, 7B the cap 118 is shown having a plurality of arched holes 140 and a center hole 142. A rotating valve tab extends through center hole 142. In FIG. 7B a track 144 is shown. Track 144 mates with other elements of the rotating valve simply to ensure a limited range of motion of the rotating valve. This ensures that only certain internal channels are alignable. With reference to FIGS. 7C, 7D, 7E, 7F and 7G the underside of cap 118 shown in FIG. 7C and including cap center hole 142 includes a resilient over molding 170 extending from a edge of the radial area at center hole opening 142 across the substantially flat surface of the underside of the cap to a annular curved internal edge within cap 118. As shown in cross sectional view 7D the underside of cap 118 includes a resilient annular member 150 and a cap underside structure 152. Detail at FIG. 7E shows underside structure 152 having a resilient annular member 158 extending from the side of structure 152 into opening 142. Resilient annular structure 158 has a radius such that a rotatable valve structure extended through cap 118 will be compressed against resilient annular structure 158 to form a seal. On the underside of cap 142 a second resilient structure extending to the arch shaped holes 140 shown in FIGS. 7A, 7B are sealed by resilient annular member 150 having a resilient annular bump 154. Bump 154 presses against the disk inserted within the rotatable valve assembly. This prevents wine from leaking through openings 142.

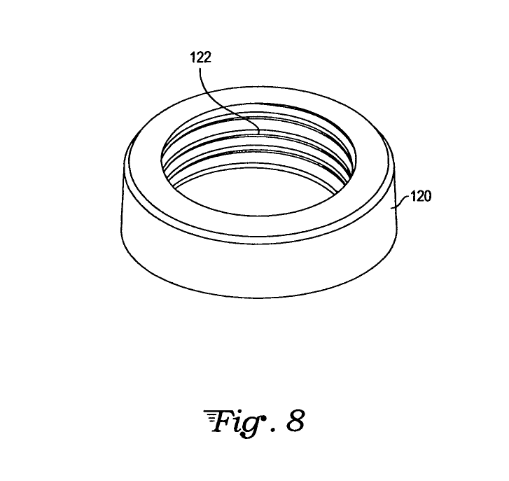

With reference to FIG. 8, a nut 120 having internal threads 122 may be attached to the threads 110 on bottle extending cylinder 108. This nut serves as the limit for insertion of the dispense head into a wine bottle. The dispense head may then be removed by rotating the nut which would then force the dispense head with the mounted gasket from the wine bottle neck.

The removal and exchangeable gaskets, the modified cap ceiling design and the removable dispense head designs may be used individually or in any combination on dispense heads. This provides advantages, such as greater resistance to leaking or greater ability to clean parts of the device.

Bottles can have a number of different opening sizes: for example 0.67 inches, 0.73 inches, 0.78 inches, 0.81 inches and 0.855 inches are all bottle opening sizes that are not uncommon. Thus the smallest adaptive gasket will accommodate the smallest bottle opening, and the largest gasket accommodate the largest opening. Implicit in the above detailed description of these embodiments are that a variety of gaskets are needed to allow proper sealing to the different wine bottles. Also seen in this system is that the solution is going to require both modification to the bottom of the stopper cylinder and the top. In the above embodiment, the bottom of the cylinder is modified from the earlier design to include threads that allow the gasket to be mounted.

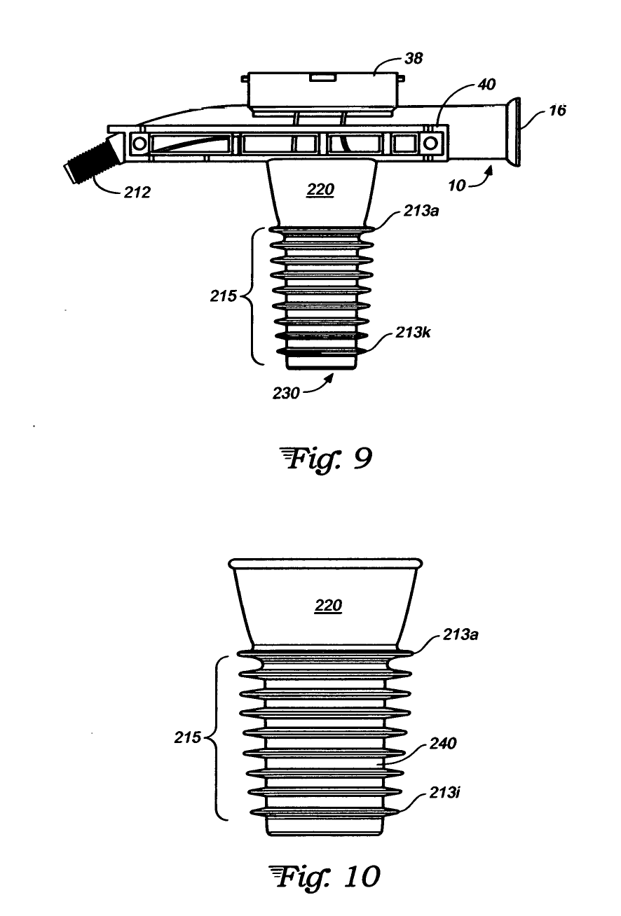

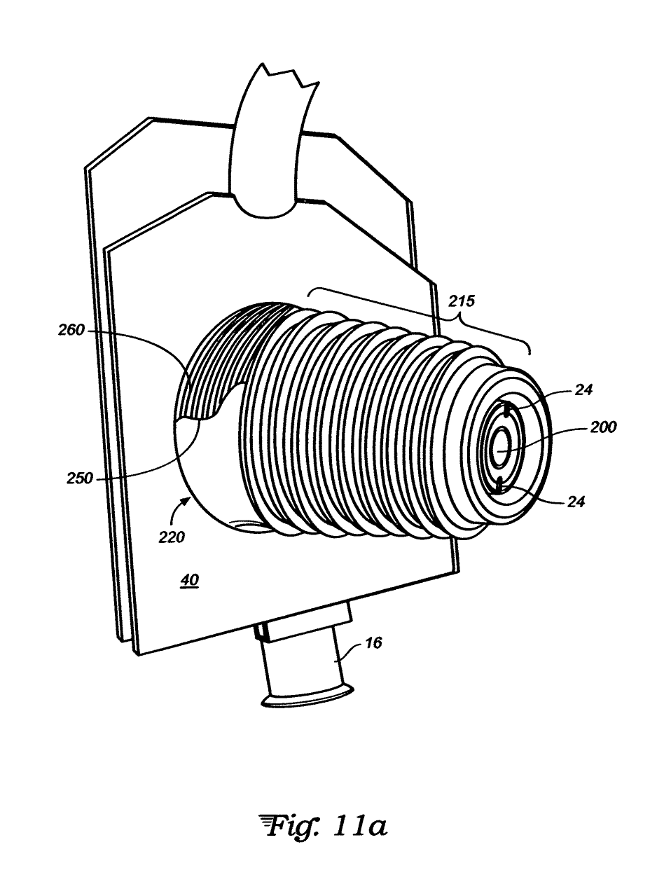

With reference to FIGS. 9 and 10, an alternative embodiment for a leak resistant dispense head is shown. As in the earlier embodiment, the gaskets were removable. So for a relatively narrower bottle opening, a narrower gasket would be used, and for a wider bottle opening a wider gasket would be used. The present dispense head embodiments are unique: as described in U.S. Pat. No. 7,712,631, which is incorporated by reference for all purposes herein, the dispense head allows gas displacement of a bottle held in a bay. The bottle does not have support at the bottom, it is supported entirely by the dispense head. A good frictional support of the stopper is thus important. Not only must the seal be gas tight, it must also support the weight of the bottle when full of liquid. The gaskets described are able to do this by more closely matching to the diameter of the opening on the wine bottle and having a sealing structure as described. In the alternate embodiment, a plurality of stacked annular flanges 215 act as the gaskets.

Again, with reference to FIGS. 9 and 10, the dispense head 10 is shown in a simplified form. As in other embodiments, a gas input 16 extends from the rear or dispense head 10. In this embodiment, a treaded mount 212 is used for attachment of a dispense spout. This allows the dispense spout to be mounted by simply screwing on a mating spout (not shown) onto threaded mount 212. The spout can then be separately cleaned and sterilized, and reattached to the dispense head. Alternatively, a dispense spout such as 1-4, or the dispense spout embodiment of FIG. 6 could be used. One advantage of the dispense spouts of FIGS. 6 and 9 is that the spouts can be easily and quickly replaced while the dispense head is still on a bottle, and the bottle is still sealed. If a user wants for any reason to replace the spout, the old spout can be removed and replaced while the bottle is still sealed. This ensures that no outside gasses or other contaminants will enter the bottle, even while a spout is exchanged. This can be important when dispensing wine, which can be expensive (over $100 per bottle) and degrades over time if exposed to air.

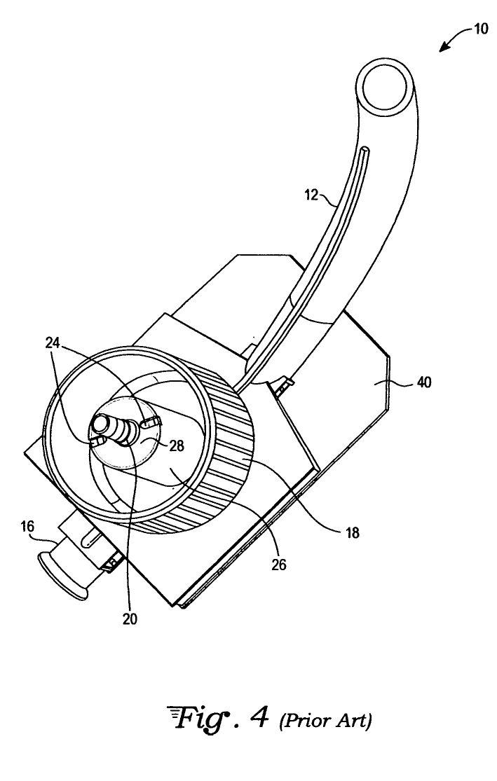

At the bottom of dispense head 10 is a gasket structure for sealing the bottle and ensuring a gas tight fit that allows support of a bottle. This device can fit over a tapered cylinder such as that shown as element 26 in FIGS. 3 and 4. Alternatively, the entire gasket structure can be made as a unitary part. The gasket structure includes a tapering cylindrical base 220. Below tapering cylindrical base 220, mounted on a cylindrical core 240 is an annular flange stack 215. The uppermost annular flange 213a has the greatest diameter, and the lowermost annular flange 213k in FIG. 9 (213i in FIG. 10) has the smallest diameter. The sizes in this illustrated embodiment range from 0.862 inches at the greatest diameter to 0.63 inches at the smallest diameter. This taper in the annular flange stack is a 4 degree taper. This annular flange stack allows a gas tight seal on bottles having openings ranging from 0.67 inches diameter to bottles having 0.855 inches opening. The dispense head can be installed on the bottle by simply inserting the annular flange stack into the bottle opening and pushing with even pressure. The dispense head can be removed in the same manner. The annular flange stack allows the bottle to be both sealed in a gas tight manner, and be installed sufficiently securely such that the bottle can hang in a bay supported only by the dispense head, even when the bottle is full. No support under the bottle is required.

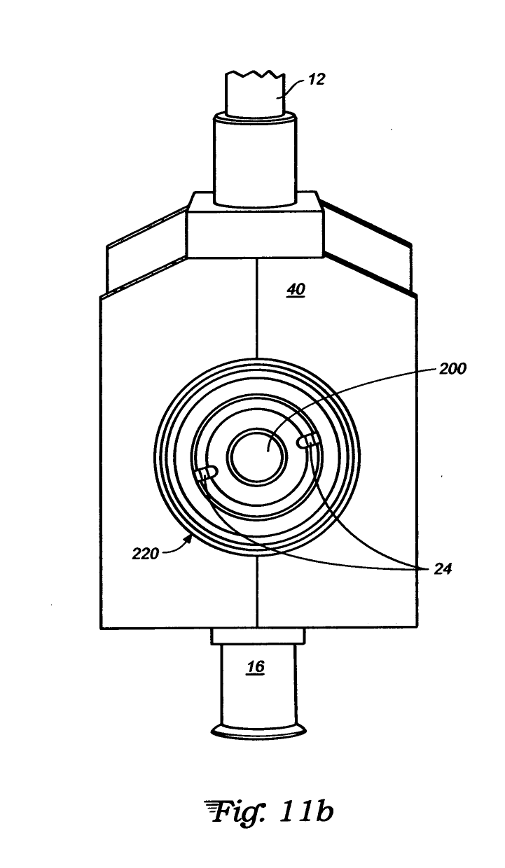

With reference to FIGS. 11A and 11B, the embodiment of the dispense head is shown from the underside. As in other embodiments, the gas input 16 is at the back of the dispense head on dispense head body 40 and the dispense spout 12 is on the front of dispense head body 40. The tapering cylindrical base 220 is mounted on dispense head body 40. Opening 200 allows mounting of a tube that extends to the bottom of a wine bottle. Gas ports 24 allow gas to be introduced into the bottle, establishing a head of gas over the liquid in the bottle. This allows purging of the gas in the bottle and replacing this gas with an inert gas. It also allows displacing a precise volume of liquid from the bottle.

FIG. 11A shows a partial cutaway 250 in tapering cylindrical base 220. This cutaway reveals internal threads 260 on the interior surface of hollow cylindrical base 220. This provides a structure to mount the tapering cylindrical base onto nut threads 110 on cylinder 108 shown in FIGS. 5A, 5B. The elongate body of cylinder 108 provides support for the annular flange stack 215.

Threaded mounts are shown in both FIGS. 5a, 5b (element 112) and in FIG. 11a (threads 260 mountable on element 110 in FIGS. 5a, 5b. Other gasket attachments are possible. A pin or bolt could be used as long as the head was recessed sufficiently to allow the gaskets to seal against a bottle neck. Screws could be used to secure the gasket or annular stack. A raised annular ridge on the stopper cylinder and a receiving groove on an abutting surface of the gasket could also act as a mount.

It should be realized that a number of alternatives, modifications, or alterations of the device is possible. The device is able to be inserted into a bottle that contains liquid. The bottle may then be suspended by the dispense head without support for the bottom of the bottle. Liquid may be dispensed by the bottle by gas displacement, or any other means desired (including pumping the liquid, or other dispensing modalities). The bottle will not leak, it remains gas tight, and the dispense head will both seal the bottle and prevent leaks. The embodiments described are examples of how this can be effected, but other alternatives are certainly possible. The devices shown in FIG. 10 is made of food grade silicone. Dimensions (in inches) are given. Any stopper or gasket of similar resiliency would also be suitable, as this alternative gasket would also deform when inserted into the bottle, seal against the inner wall of the glass neck of a bottle, and provide a gas tight seal that is also capable of supporting the bottle.

In the broadest envisioning of the invention, it is a dispense head of the type attached to a bottle to allow dispensing of liquid. Such a dispense head has
1. a dispense head body;
2. a port or other means to connect to a liquid removal force generator (e.g. displacement gas or pump). While a port is preferred (because it makes the bottle removable from the system and replaceable with another bottle which has a similar dispense head)
3. a valve for controlling force from the liquid removal force generator,
4. a tube extending to the bottom of the bottle, mounted on a tube stopper; and
5. a mount for a dispense spout. This may be integrated into the dispense spout (as shown in FIG. 3, may be a spout mount 102 shown in FIGS. 5a, 5b or similar structures, may be a threaded spout mount 212 as shown in FIG. 9, or may be any other spout mount; and
6. a plurality of gaskets that allow adapting said tube stopper to bottle necks of different diameters. This plurality of gaskets may be either at least two deformable, attachable cylindrical, resilient gaskets that are separately mounted on the tube stopper, or an annular flange stack, such as annular flange stack 215 shown in FIGS. 9, 10, and 11a, 11b.

An alternative way of conceiving of the invention is as a method to dispense a liquid. The method would include the steps:
1. Inserting a dispense head into a liquid bottle, wherein a resilient gasket of a selected size provides sufficient force to both allow said bottle to be supported from the neck and to seal said bottle in a gas tight manner during liquid dispensing; and
2. Dispensing said liquid from said bottle. The present document also discloses various embodiments for attachment of dispense spouts. These are especially useful for the type of dispense heads described herein and described in U.S. Pat. No. 7,712,613 earlier incorporated by reference. This type of dispense head has a valve that seals the bottle after dispensing, allowing a bottle to be removed from a dispense system and replaced with another bottle that has a similar dispense head. Having a spout that is removable allows the spout to be replaced if bent, damaged or dirty, while still allowing the bottle to remain sealed and not exposed to air (which could degrade liquid within the bottle).

What is claimed is:

1. A dispense head, comprising:
a dispense head body;
a port on said dispense head body, said port configured to allow connection to a liquid removal force generator;
a valve in liquid communication with said port, said valve placed to allow control of a force from the liquid removal force generator transmitted through said port;
a stopper mounted on said dispense head body;
a tube extending into a hollow core of said stopper;
a mount for a dispense spout;
wherein said mount, said valve, said tube and said port are positioned in relation to each other that (1) in an open state of said valve, a liquid removal force carried through said port and transmitted through said valve, draws liquid through said tube and out said mount for a dispense spout, and (2) in a closed state of said valve allows no flow through either said tube, said mount for a dispense spout or said port, effectively sealing a bottle onto which said dispense head is mounted; and
a plurality of gaskets associated with and placable on said stopper, said gaskets proving a liquid and gas tight seal on said bottle specific to a neck opening size of said bottle.
